(19) United States
(12) Patent Application Publication
(10) Pub. No.: US 2015/0342414 A1
(43) Pub. Date: Dec. 3, 2015

(54) SYSTEM FOR PRODUCING UNIFORM SERVING PORTIONS IN A PAN-PREPARED COMESTIBLE

(71) Applicant: JANET PROTAS, DALLAS, TX (US)

(72) Inventor: JANET PROTAS, DALLAS, TX (US)

(21) Appl. No.: 14/736,414

(22) Filed: Jun. 11, 2015

Related U.S. Application Data
(63) Continuation of application No. 13/539,455, filed on Jul. 1, 2012.
(60) Provisional application No. 61/504,172, filed on Jul. 2, 2011.

(51) Int. Cl. A47J 45/10; A47J 47/00

(52) U.S. Cl. CPC A47J 45/10; A47J 47/005

(57) ABSTRACT

System for removing a pan-prepared comestible from a pan and dividing the comestible into desired portions includes an article including a substrate with portions thereof placed between a pan-prepared comestible, such as a baked or chilled item, and portions of the substrate extending beyond at least two sides of the pan, which define handles for lifting the pan-prepared comestible from the pan. The system includes indicia which includes printed, raised or embossed markings, indicators, or symbols visible on the substrate beyond the bounds of the comestible once separated from the pan, and which define portioning lines serving as guidelines for a cutting tool whereby the comestible is divided into uniformly shaped portions.

### CROSS REFERENCE TO RELATED APPLICATIONS

This Application is a Continuation Application of U.S. Ser. No. 13/539,455 Titled “System for Producing Uniform Serving Portions in a Pan-prepared Comestible” and filed Jul. 1, 2012, which claims benefit of U.S. Provisional 61/504,172 filed Jul. 2, 2011

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### FIELD OF THE INVENTION

The present invention relates generally to systems and means for dividing a pan-contained comestible into a number of uniformly sized and shaped serving portions, and more particularly to an article that resides between a pan-prepared comestible and the pan, which provides (1) a removal means for the comestible from the pan, and (2) a portioning means by way of indicia about the perimeter of the removed comestible which enable a user to section the comestible into uniform serving portions.

### BACKGROUND OF THE INVENTION

Various systems for dividing a pan-baked item into smaller pieces are known in the art. U.S. Pat. No. 6,726,944 to Blaschke et al. discloses pre-scored dough that may be separated into smaller pieces after baking Others are known to use a gridwork of partitions as a dividing means which are installed in the baking pan prior to baking and which divide the baked item into serving portions during baking, or a gridwork which is employed as a die and pressed into a baked item after baking, in order to divide the baked item into uniform portions. While the foregoing solutions work well for their intended use, they are not without disadvantages. Pre-scored dough is not an option for a baker producing scratch-made dough, or when using a premix. The foregoing devices often possess a non-stick surface like teflon which some bakers prefer not to use. Such devices also result in a plurality of portions that must be removed separately from the baking pan often destroying the uniformity of adjacent portions and undermining the aesthetics of presentation.

The present invention eliminates the aforementioned disadvantages by providing a system having a removal means for safely and quickly removing a pan-prepared comestible, whether a baked item from a baking pan, or a cold prepared food such as jello, and a guiding means for guiding the cutting of the comestible into uniform shapes and sizes. Both the removal means and the guiding means are embodied in an article which can be baked or chilled. The system provides a means for dividing the pan-prepared comestible into smaller uniformly shaped and sized serving portions.

In addition to providing a means for cutting a pan-prepared comestible into plural uniform shapes, it would be desirable for a system to provide a safe removal means for the removal of the pan-prepared comestible from the pan.

It would be desirable for such a system to provide a portioning guide to enable cutting the pan-prepared comestible into uniform shapes of various sizes.

### SUMMARY OF THE INVENTION

The present invention is a system including an article for removing a pan-prepared comestible from a pan and guiding the cutting of the pan-prepared comestible into uniform shapes and sizes to obtain a desired portioning of the comestible. The article possesses a portioning means which includes a sheet substrate such as oven-safe parchment with or without a non-stick component, or a sheet of oven-safe silicone having printed, embossed or raised indicia thereon representing portioning guidelines which enable a user to divide the pan-prepared comestible by cutting it into uniform serving sections.

In one aspect of the present invention including parchment or other substrates having indicia, the portioning guide possesses indicia intended for sizing purposes that can be indicated by marking, printing, perforation, incising or any combination thereof to enable a user to cut or tear the sheet substrate for sizing to a particular baking pan. Still other indicia is represented by portioning lines which enable the user to make evenly spaced cuts through the pan-prepared comestible in order to produce uniformly shaped and sized portions. The indicia intended for sizing can also have perforations along their length to assist with the removal of unneeded sections of the portioning guide.

In another aspect of the present invention, whatever the substrate, the portioning guide can be generally cruciform and supplied in a plurality of sizes corresponding to pan size.

In yet another aspect of the present invention, the portioning guide includes a substrate taking the form of a rectangular sheet with indicia thereon represented by both portioning lines and sizing lines whereby the user may size the sheet by cutting the sheet with a pair of shears or a utility blade to size the sheet for a particular pan.

Other flexible removal means for comestibles either with or without non-stick means will suggest themselves to persons of ordinary skill in the art. Therefore, the present invention is considered to encompass any suitably heat, cold and moisture resistant materials which may be positioned and reside in situ during a baking or chilling process between a comestible and a baking pan.

The present invention also encompasses a method for cutting a baked or chilled item into uniformly shaped and sized pieces which includes at least a series of steps using the foregoing article to obtain uniformly shaped and sized portions. The present invention provides a guiding means for a cutting tool such as a knife for obtaining plural sets of uniformly shaped and sized portions from a pan-prepared comestible, and a removal means including handle means whereby the pan-prepared comestible can be removed from the pan without sticking, or risking burn injury of the baker's hands. The aforementioned means can be embodied in both disposable and non-disposable articles.

Other object features and advantages of the present invention will become apparent from the following descriptions, taken in connection with the accompanying drawings wherein by way of illustration and example, preferred embodiments of the present invention are disclosed.

### BRIEF DESCRIPTION OF THE DRAWINGS

In the following figures, all measurements for pans are given in inches. Measurements for pan depth have been omitted, but can be 1.0-4.0 inches in depth and are typically 1.0-3.0 inches in depth depending on use. The pans can be cake, tart or loaf pans, among others.

FIG. 1 is a plan view of an article for use with the present invention with solid sizing lines 18 to accommodate pans of either 9×13, or 9×9 inches;

F1G. 2 is a plan view of an article for use with the present invention with dashed sizing lines 18 to accommodate pans of either 9×9 or 9×13 inches;

FIG. 3 is a plan view of an article for use with the present invention with solid sizing lines 18 to accommodate pans of 9×9, 9×13, or 8×8 inches;

F1G. 4 is a plan view of an article for use with the present invention with sizing lines 18 and R1 which can differ in density, thickness and color to border regions of the article intended for removal;

FIG. 5 is a partial plan view of the top left corner of an article for use with the present invention with sizing lines R1 which differ in density, thickness and color to border regions of the article intended for removal;

FIG. 6 is a detail view of a typical section of the article depicted in (FIG. 1) according to the present invention;

FIG. 7 is another detail view of a typical section of the article depicted in (FIG. 2) according to the present invention with perforations indicated by the dotted white lines along the sizing lines 18;

FIG. 8 is another detail view of a typical corner section of the article shown in (FIG. 4) showing a removable region bounded by sizing lines R1;

FIG. 9 is a plan view of an article for use with the present invention which has been sized to fit a pan having 9×13 inches in dimension by removing the rectangular portions at the corners of the bold sizing lines 18;

FIG. 10 is a perspective view of the article for use with the present invention, showing free portions 20 extending beyond the upper edges of the pan;

FIG. 11 is a perspective view of the article for use with the present invention, showing free portions 20 being used as handles to lift a baked item free of a pan;

FIG. 12a is a plan view of an article for use with the present invention which has been lifted free of the pan, and laid flat along with the centered baked item ready for cutting;

F1G. 12b is a plan view of an article for use with the present invention which has been lifted free of the pan, and laid flat along with the centered baked item ready for cutting;

FIG. 13 is a plan view of an embodiment in which at least one pan size lacks indicia in the section corresponding to the bottom of the comestible;

FIG. 14 is a plan view of an embodiment having recipe ingredients and directions for preparation printed within removable sections in the upper left and right hand corners of the article;

FIG. 15 is a plan view of an embodiment having indicia taking the form of symbols to assist in sizing the portioning guide;

### DETAILED DESCRIPTION OF THE INVENTION

Partial Reference listing of the Numbered Elements:

12 portioning guide

14 grid square

16 portioning indicia

18 sizing indicia

20 handle portions

22 pan-prepared comestible

Definitions

In the following description, the term “pan” refers to any type of pan for comestible preparation, which includes, but is not limited to pans made of steel, stoneware, silicone, aluminum, cast iron or glass, or combinations thereof “Pan-prepared” refers to comestibles prepared in a pan for oven baking or chilling. “Comestible” is an item prepared for consumption. “Indicia” refers to any marking or indicator for cutting, separating or demarking one section from another which can include solid lines, raised or recessed sections, dashes, dots, perforations, and printed symbols. “Cutting tool” refers to any hand held tool capable of cutting or dividing a pan-prepared comestible such as a conventional knife, spatula or icing knife. Unless otherwise explained, any technical terms used herein have the same meaning as commonly understood by one of ordinary skill in the art to which this disclosure belongs. The singular terms “a,” “an,” and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” Publications, patent applications, patents, and other references mentioned herein, if any, are incorporated by reference in their entirety for all purposes. In case of conflict, the present specification, including explanations of terms, will control. In addition, the materials, methods, and examples are illustrative only and not intended to be limiting.

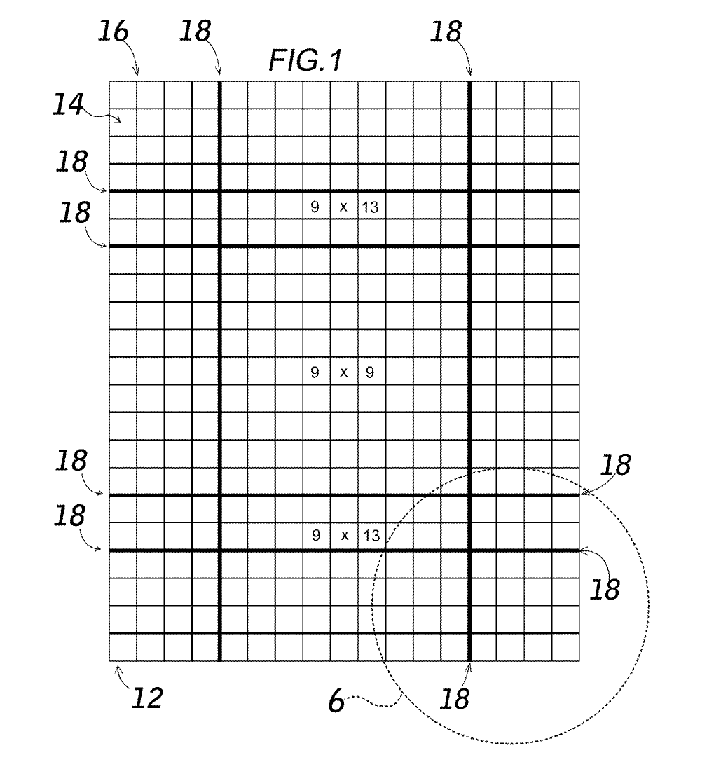

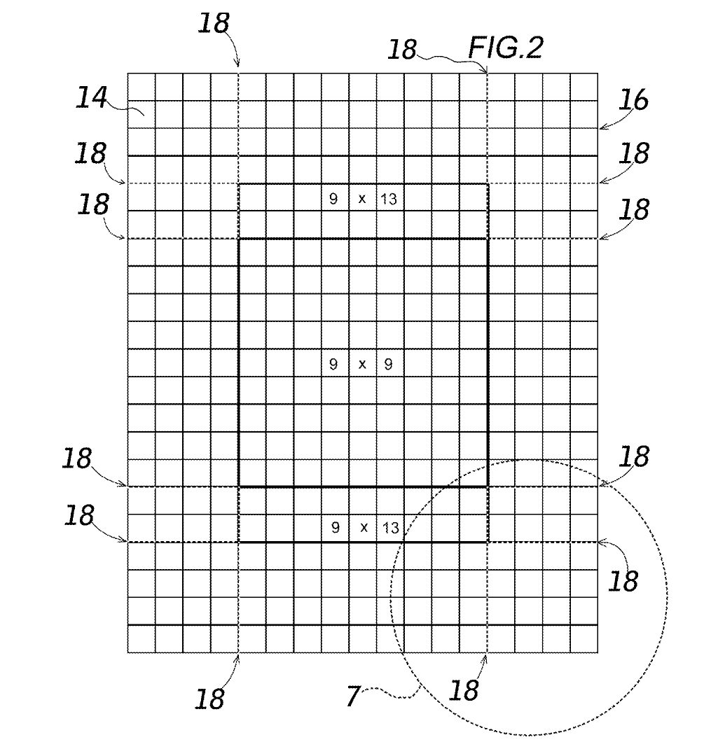

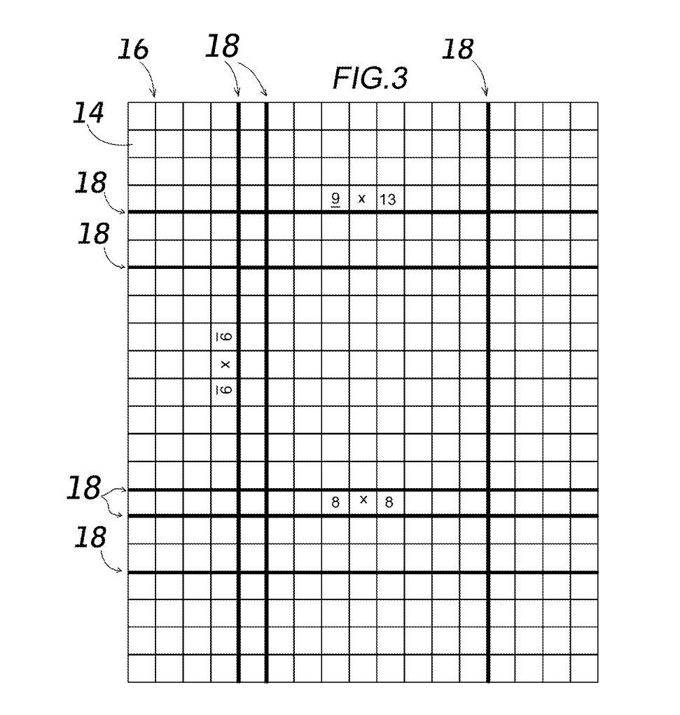

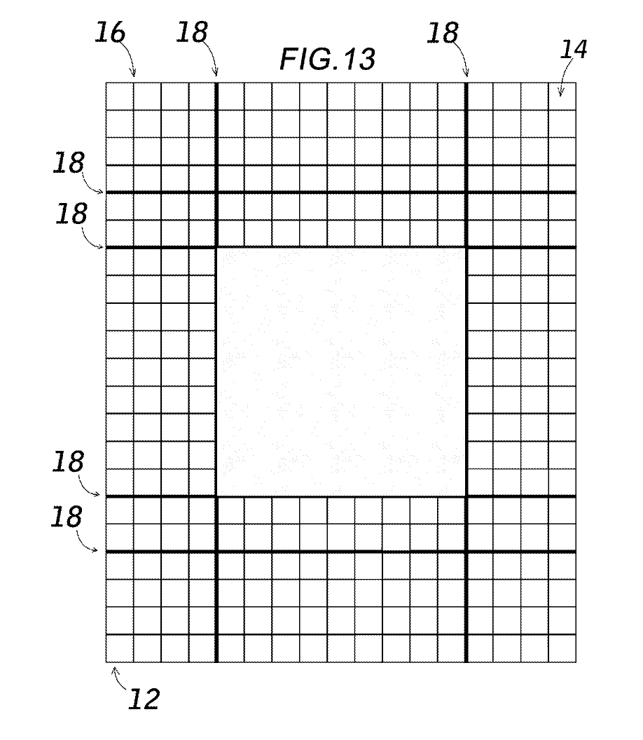

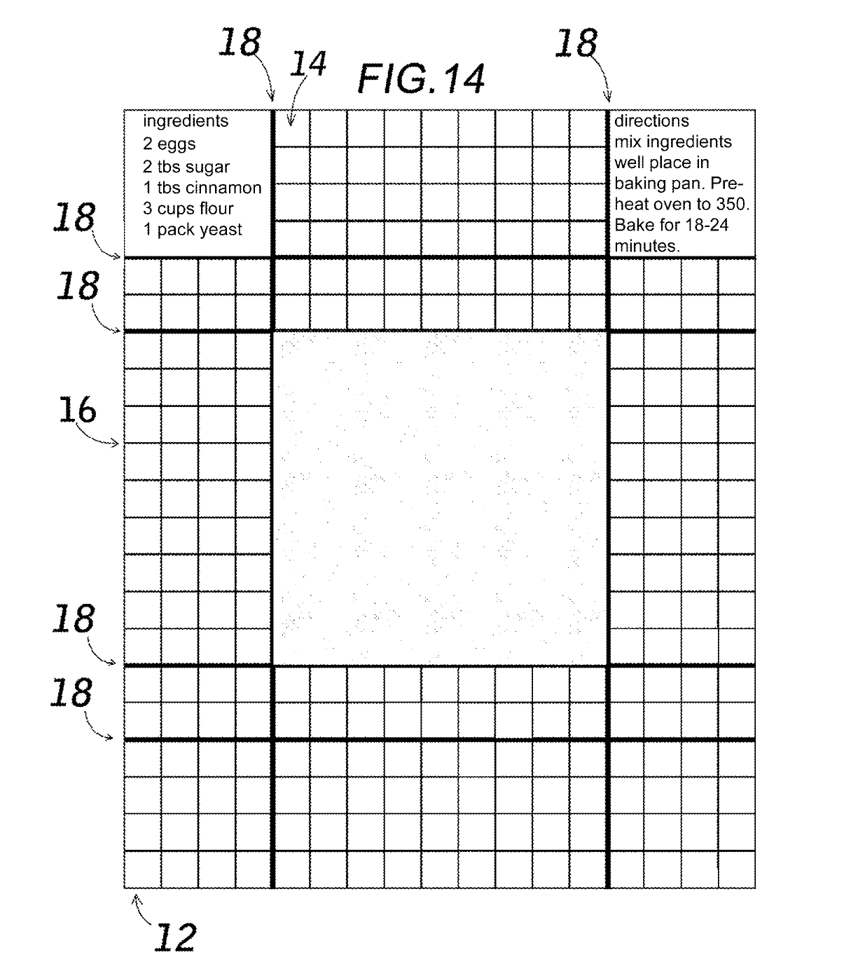

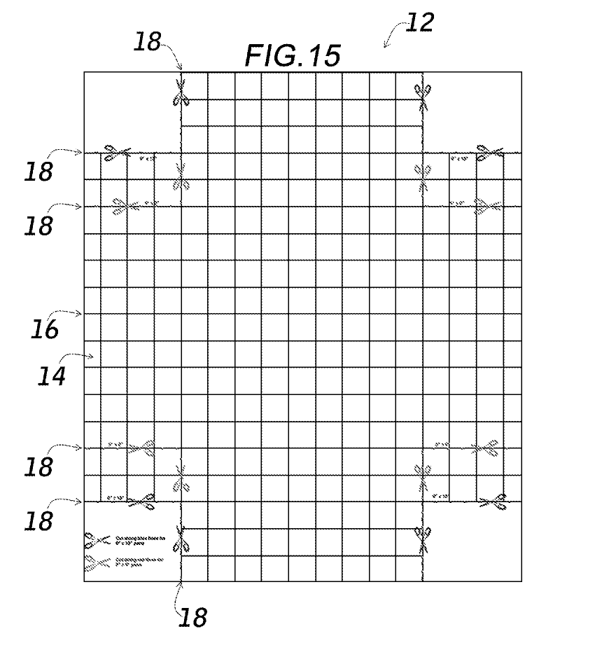

Referring generally to FIGS. 1-15; a system includes a portioning guide 12 for dividing a pan-prepared comestible into smaller uniformly shaped and sized serving portions. The article includes a length of material, which can be baking parchment, silicone sheet or other suitable heat, cold and moisture resistant material with or without a release agent which can be inherent to the article, or can be added to the article. The article can be provided in the form of separate sheets or in roll form. The portioning guide includes portioning indicia 16 represented by at least a series of portioning guidelines for portioning. The portioning guide also includes sizing indicia represented in the particular embodiment shown, by relatively thicker sizing lines 18 which border regions that must be separated from the sheet by cutting or tearing in order to match the portioning guide size to that of a pan. The sizing lines typically bound rectangular portions at the corners of the portioning guide. The sizing lines can be (1) substantially thicker than other indicia, (2) overlay portioning lines, and (3) can be semi-transparent with or without color coding to correspond to specific pan sizes. Although three sizes are shown in the figures, other sizes of pan can be accommodated by enlarging or reducing the sheet size and adding additional sizing lines. For example, FIG. 3 includes sizing lines which allow the article to fit pan sizes (9×13×2), (9×9×2) and (8×8×2).

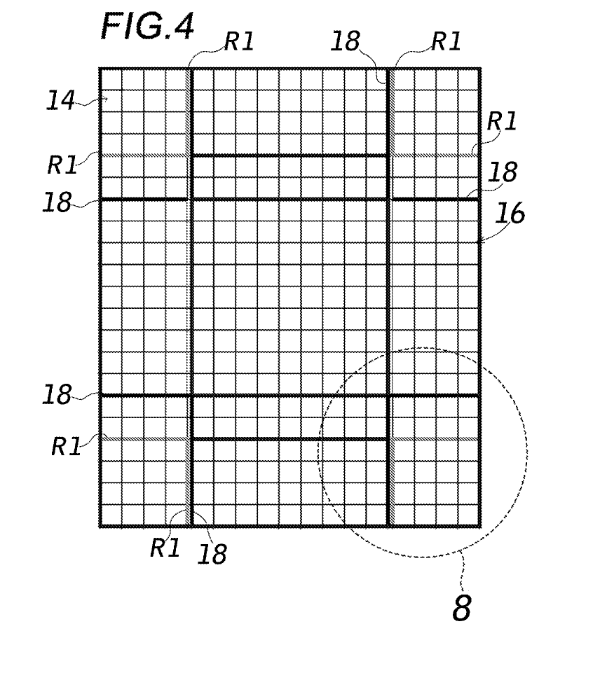

FIG. 5 is a partial plan view of a typical corner of a portioning guide which has relatively thin portioning lines defining a grid which has regions intended for removal bounded by sizing lines R1 which are thicker and semi-transparent so that the portioning lines can be seen beneath. Sizing lines R1 can be adjacent to sizing lines 18 creating a gap therebetween. Instructions for section removal as well as recipes, directions, or advertising and the like, can be printed on the portioning guide adjacent to the sizing lines.

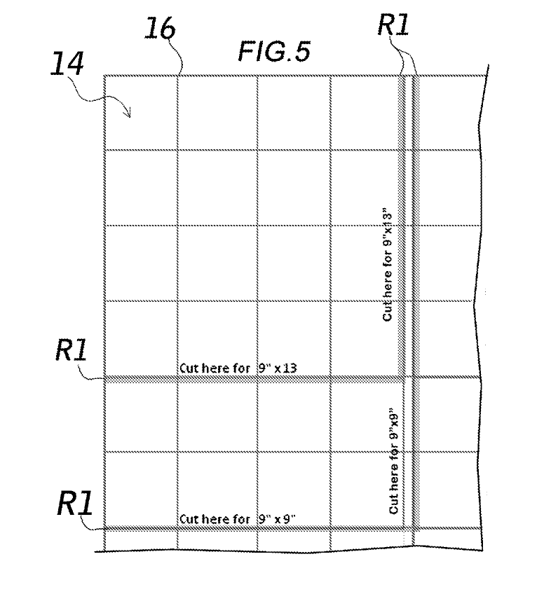

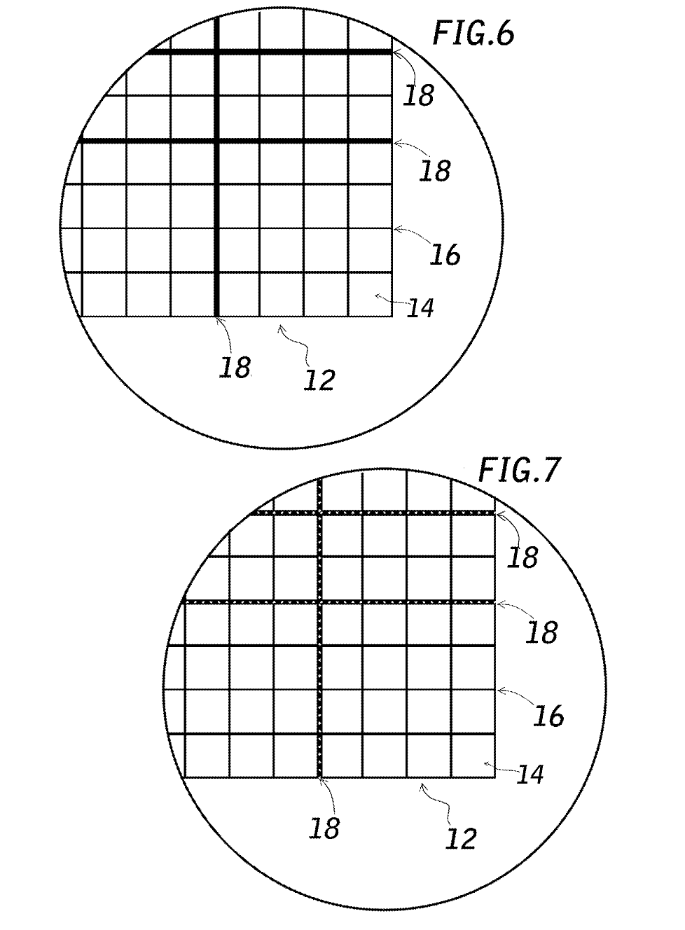

As shown in FIGS. 6 and 7 respectively, the sizing lines 18 can be simply bold lines which are followed and cut with scissors, or the sizing lines can include perforations alone or in combination with other overlying indicia so that the portioning guide may be readily sized by tearing.

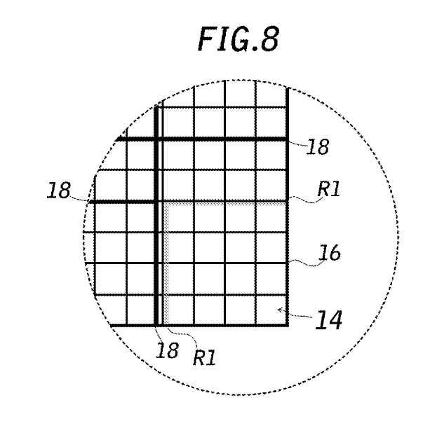

FIG. 8 is a detail view of the embodiment shown in (FIG. 4). The sizing lines R1 are separate and adjacent to sizing lines 18, are substantially thicker than the portioning lines 16 and border rectangular sections of the portioning guide 12 intended for removal. All sizing lines whether contiguous or separated can be semitransparent allowing thinner portioning lines to show through the sizing lines.

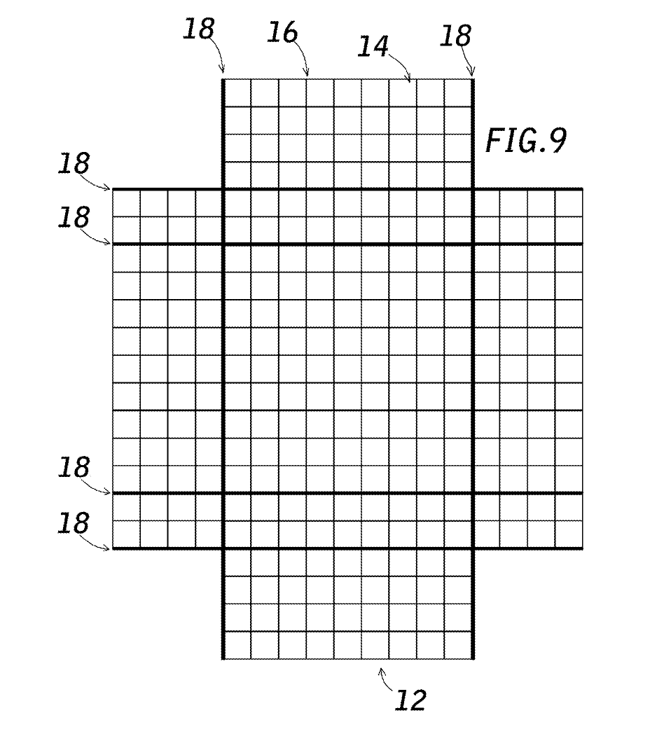

FIG. 9 shows the portioning guide having been sized to match a (9×13×2) pan.

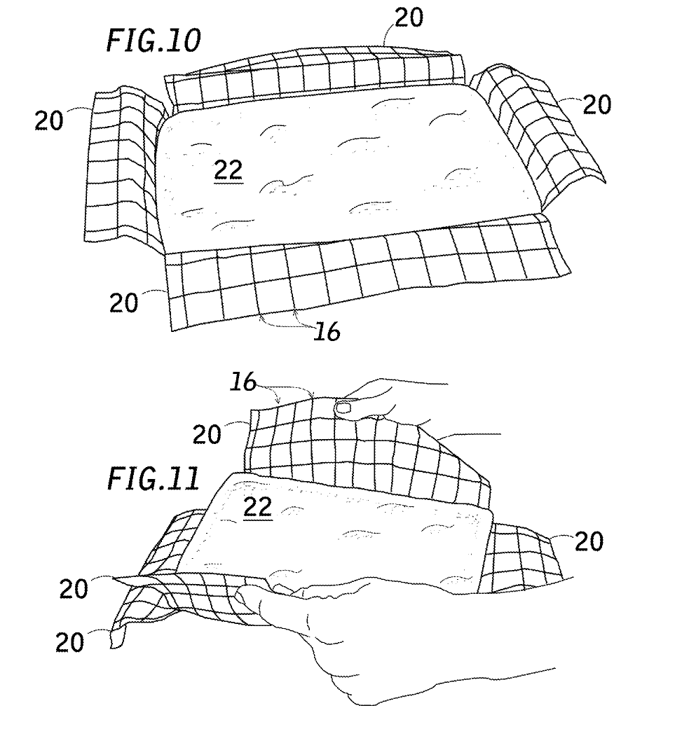

Referring to FIGS. 10 and 11, once the portioning guide has been sized, it is placed in a pan prior to baking or chilling and serves as a pan liner. When the comestible is ready to serve, the comestible 22 is lifted from the pan by the extended sections of the portioning guide forming handle portions 20 that extend beyond the upper edges of the pan.

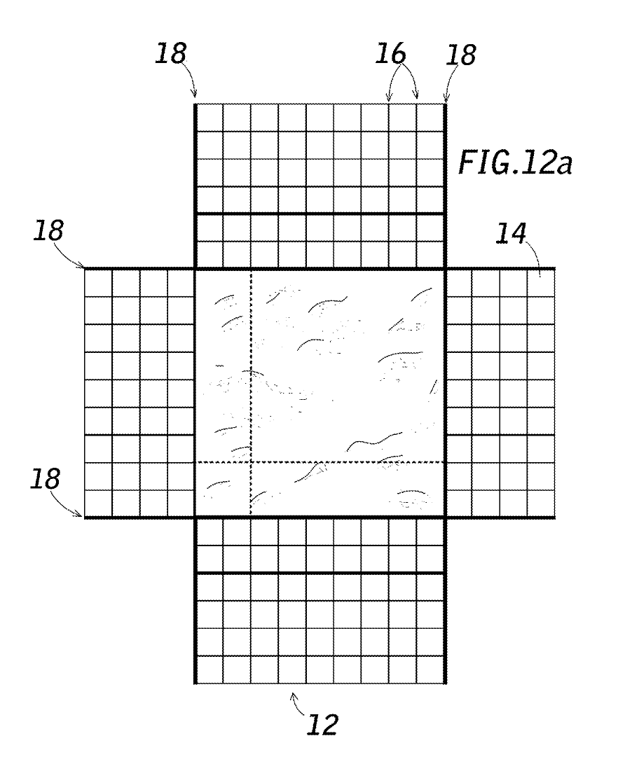

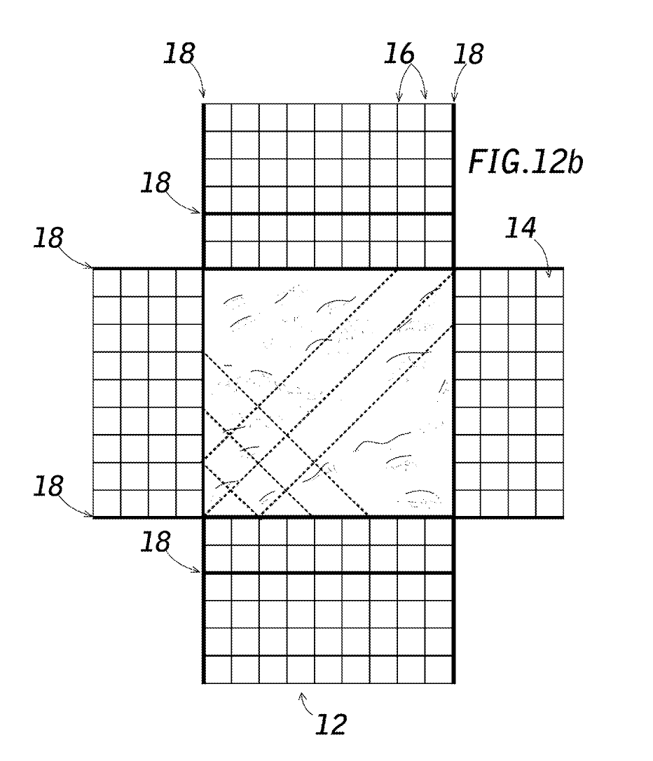

Referring to FIGS. 12a and 12b, once the comestible has been lifted from the pan, it is placed on a flat surface with the free sections of the portioning guide surrounding the periphery of the comestible. The portioning lines 16 are followed preferably with a knife or other suitable tool to produce uniformly shaped and sized portions which can be squares, diamonds, rectangles or other shapes. FIG. 12a shows two initial cut lines indicated by dashed lines producing a first 2 inch×2 inch portion. FIG. 12b shows a series of six cut lines producing four diamond shaped portions and four triangular portions. The pan-prepared comestible can be divided into a single set of uniformly sized one-inch square portions, or a mix of both square and rectangular portions, or other shapes and sizes.

While other uses of the present invention will doubtless suggest themselves to those skilled in the art, and are considered to be included in the invention, the following represent exemplary series of steps which can be performed to obtain uniformly shaped and sized pan-prepared comestibles using the portioning guide of the present invention:

### Example One

(1) The portioning guide 12 is sized by the user by removing a predetermined section of the portioning guide indicated by sizing lines 18 which function as a template for sizing the dimensions of the portioning guide to fit into pans of varying dimensions; and,

(2) once the portioning guide is sized appropriately, it is placed into the pan; and,

(3) with the portioning guide thus inserted, at least two free sections now extend past the upper lip along each top edge of the pan; and,

(4) the pan is filled with a comestible to be prepared with the portioning guide residing between the comestible and the walls of the pan; and,

(5) once the comestible is ready for consumption, it is lifted free of the pan using the free sections 20 of the portioning guide extending beyond the upper lip of the pan, which form handles, the portioning guide acting as a sling for the comestibles; and,

(6) once the pan-prepared comestible is placed on a level surface, the unconstrained lengths of the portioning guide at the vertical sides of the pan-prepared comestible are laid open on the flat surface. A network of indicia is now evident about the perimeter of the comestible and define portioning lines 16 for cutting the pan-prepared comestible into a plurality of uniformly shaped and sized portions.

### Example Two

(1) The portioning guide 12 is supplied pre-sized for a specific size of pan; and,

(2) the portioning guide is placed into the pan; and,

(3) with the portioning guide thus inserted, at least two free sections now extend past the upper lip along each top edge of the pan; and,

(4) the pan is filled with a comestible to be prepared with the portioning guide residing between the comestible and the walls of the pan; and,

(5) once the comestible is ready for consumption, the comestible is lifted free of the pan using the free sections 20 of the portioning guide extending beyond the upper lip of the pan, which form handles, the portioning guide acting as a sling for the comestible; and,

(6) once the pan-prepared comestible is placed on a level surface, the unconstrained lengths of the portioning guide at the vertical sides of the pan-prepared comestible are laid open on the flat surface. A network of indicia is now evident about the perimeter of the comestible and define portioning lines 16 for cutting the pan-prepared comestible into a plurality of uniformly shaped and sized portions.

While the invention has been described by the embodiments given, it is not intended to limit the scope of the invention to the particular forms set forth. While the indicia intended for both portioning purposes and sizing purposes preferably take the form of solid lines which are spaced in one inch intervals, the indicia can take the form of markings, symbols or indicators which can be spaced at any interval and can vary in thickness and color. The total number of portioning lines, the spacing of the portioning lines, and the ratio of portioning lines to sizing lines can vary. A portioning guide can have sizing indicia for a single pan or for more than one size of pan. Multiple indicia present on the portioning guide can be color coded to differentiate between mutiple sizing indicia if present, and between multiple portioning indicia if present. Sizing indicia can be color coded to indicate pan size, and alternately take the form of solid colored blocks or sections. Sections of the portioning guide intended for removal can be free of color, text or other indicia within their bounds, or can include among other markings, indications of pan size. The portioning guide can be supplied pre-sized having a generally cruciform shape. When supplied in a generally cruciform shape, lengths of projecting sections can vary. Furthermore, the portioning lines can be present only at the periphery of the substrate and therefore absent between the bottom surface of the comestible and the pan. Accordingly, the description herein is intended to cover such alternatives, modifications, and equivalents as may be included within the spirit and scope of the invention as defined by the appended claims.

I claim:

1. An article for removing a pan-prepared comestible from a baking pan and dividing the comestible into desired portions comprising:
1) a cruciform shaped one-piece heat and cold resistant article in sheet form having a central rectilinear portion and two arms extending from the central portion, configured for placement in a baking pan with arm portions of the article configured to extend past upper edges of the baking pan and providing handles for lifting the comestible free of the baking pan after baking; and,
2) a pre-printed grid on the article arms, defining cutting guidelines for a cutting tool when the comestible has been removed from the pan, and the article arms laid flat whereby the comestible may be divided uniformly.

2. A method for removing a pan-prepared comestible from a baking pan and dividing the comestible into desired portions comprising:
(1) providing a cruciform shaped one-piece heat and cold resistant article in sheet form having a central rectilinear portion and two arms extending from the central portion, configured for placement in a baking pan with arm portions of the article configured to extend past upper edges of the baking pan and providing handles for lifting the comestible free of the baking pan after baking, and wherein the arms possess a pre-printed grid defining cutting guidelines for a cutting tool;
(2) placing the one-piece article into a baking pan with the grid showing;
(3) placing baking mixture into the pan;
(4) baking the comestible;
(5) removing the comestible from the baking pan by lifting with the arm portions of the article, and placing the comestible on a flat surface;
(6) laying the arm portions on the flat surface, and
(7) cutting along the grid lines showing on the arms in order to divide the baked comestible uniformly.
